(19) United States
(12) Patent Application Publication
(10) Pub. No.: US 2010/0322724 A1
(43) Pub. Date: Dec. 23, 2010

(54) Positioning and cooling device for horizontal surface drilling

(75) Inventor: Weixiang Ren, Zhejiang Province (CN)

Correspondence Address: YH CHAN, 42 PIN OAKS DRIVE, PHOENIXVILLE, PA, 19460, US

(73) Assignee: Hangzhou Bofeng Diamond Tools Co., Ltd., Zhejiang Province (CN)

(21) Appl. No.: 12/540,379

(22) Filed: Aug. 13, 2009

(30) Foreign Application Priority Data
Jun. 18, 2009 (CN) 200920122358.6

(51) Int. Cl. B23B 49/02

(52) U.S. Cl. 408/56; 408/72 R; 408/241 G

(57) ABSTRACT

The present invention relates to a positioning and cooling device for horizontal surface drilling which comprises a base, a positioning hole and a water channel, characterized in that the water channel is disposed on the base, and the positioning hole is disposed at a bottom of the water channel and communicates with the base. When in use, the bottom of the base is adhered with a double-sided type or other adhesives for affixing the base onto the horizontal work surface. At the same time, the positioning hole is ensured to be aligned with the positioning point of the drill hole. Then, fill the water channel with appropriate amount of water. When the drilling apparatus drills a hole via the positioning hole, water in the water channel serves immediate cooling function and thereby effectively protecting the drill bit. The present invention solves the positioning and cooling problems of drilling apparatus and is simple in structure, convenient to operate, and effective in facilitating the positioning and cooling of drilling apparatus, and is therefore worth promoting.

### BACKGROUND OF THE INVENTION

The present invention relates to a positioning and cooling device for drilling which is an auxiliary device for drilling apparatus and more particularly pertains to a positioning and cooling device for horizontal surface drilling.

In the fields of construction, housing renovation and processing of machine parts, it is frequently necessary to drill holes on horizontal ground or work surfaces. Take the example of drilling a hole on a horizontal ground surface, conventional positioning method is to first arrange the drill bit to contact the ground surface at an inclined angle to drill a positioning point on the ground, and then align the drill bit perpendicular to the positioning point to drill a hole. This would normally rely on the skills and proficiency level of the drilling apparatus operator. As a result, this drilling method has the following deficiencies: First, positioning is inaccurate as this positioning method relies on the determination of the positioning point and if the positioning point is not accurately determined when the drill bit is in contact with the ground surface at an inclined angle, it is necessary to determine the positioning point again and so resulting in waste of time and effort. Second, there is no corresponding drill bit cooling device, so heat generated by the high speed rotation of the drill bit could not be cooled down immediately. As a result, the durability of the drill bit is affected, especially when the drill bit is under frequent use. Therefore, there is a need for an effective auxiliary device for the positioning and cooling of drilling apparatus.

### BRIEF SUMMARY OF THE INVENTION

It is an object of the present invention to provide a positioning and cooling device for horizontal surface drilling which could achieve both positioning and cooling, so that it could facilitate the drilling apparatus to perform precise drilling and at the same time facilitate the drilling apparatus to cool down.

To attain this, the present invention adopts the following technical proposal:

A positioning and cooling device for horizontal surface drilling which comprises a base, a positioning hole and a water channel, characterized in that the water channel is disposed on the base, and the positioning hole is disposed at a bottom of the water channel and communicates with the base.

In a preferred embodiment, the base is in shape of a circle or a rectangle. The positioning hole is in shape of a circle. The water channel is in shape of a circle or a rectangle.

To further elaborate, when the present invention is in use, the bottom of the base is adhered with a double-sided type or other adhesives for affixing the base onto the horizontal work surface. At the same time, the positioning hole is ensured to be aligned with the positioning point of the drill hole. An intercommunicating cylinder is formed via the positioning hole between the ground surface and the water channel. Then, fill the water channel with appropriate amount of water and a positioning and cooling device for drilling is formed. The drill bit is then inserted into the device to perform drilling. Water in the water channel could cool the drill bit immediately.

In comparison with the prior art, the positioning and cooling device of the present invention is simple in structure, convenient to operate, and effective in facilitating the positioning and cooling of drilling apparatus, and is therefore worth promoting.

### BRIEF DESCRIPTION OF THE DRAWINGS

FIG. 1 shows a structural view of an embodiment of the present invention.

The labels in the drawings are as follows: 1: base; 2: positioning hole; 3: water channel.

### DETAILED DESCRIPTION OF THE INVENTION

The technical proposal of the present invention is further described with the accompanying drawings and embodiment.

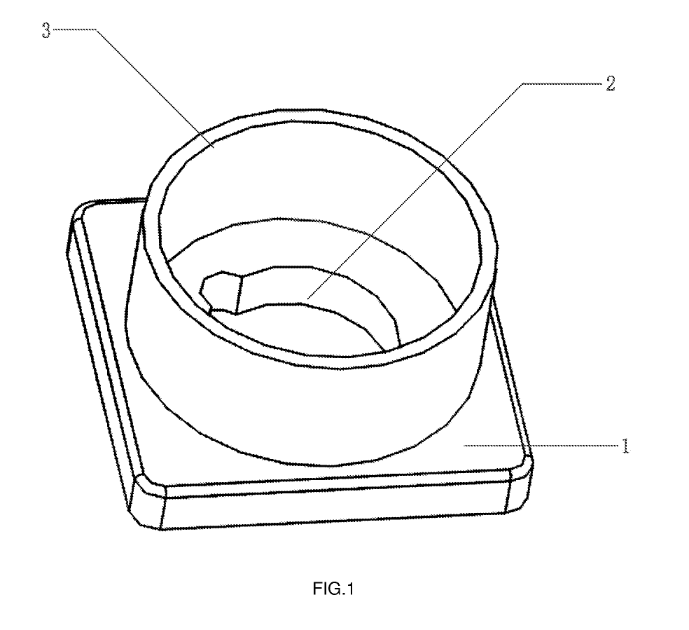

FIG. 1 shows a structural view of an embodiment of the present invention. The positioning and cooling apparatus of the present embodiment comprises a base 1, a positioning hole 2 and a water channel 3. The base 1 is in shape of a square. The positioning hole 2 is in shape of a circle. The water channel 3 is in shape of a circle. The water channel 3 is disposed on the base 1, and the positioning hole 2 is disposed at a bottom of the water channel 3 and communicates with the base 1.

When the present invention is in use, the bottom of the base 1 is adhered with a double-sided type or other adhesives for affixing the base 1 onto the horizontal work surface. At the same time, the positioning hole 2 is ensured to be aligned with the positioning point of the drill hole. Then, fill the water channel 3 with appropriate amount of water. When the drilling apparatus drills a hole via the positioning hole 2, water in the water channel 3 serves immediate cooling function and thereby effectively protecting the drill bit.

What is claimed is:

1. A positioning and cooling device for horizontal surface drilling which comprises a base (1), a positioning hole (2) and a water channel (3), characterized in that the water channel (3) is disposed on the base (1), and the positioning hole (2) is disposed at a bottom of the water channel (3) and communicates with the base (1).

2. The positioning and cooling device for horizontal surface drilling as in claim 1, characterized in that the base (1) is in shape of a circle or a rectangle.

3. The positioning and cooling device for horizontal surface drilling as in claim 1, characterized in that the positioning hole (2) is in shape of a circle.

4. The positioning and cooling device for horizontal surface drilling as in claim 1, characterized in that the water channel (3) is in shape of a circle or a rectangle.
